(19) United States
(12) Patent Application Publication
(10) Pub. No.: US 2006/0153120 A1
(43) Pub. Date: Jul. 13, 2006

(54) Method, apparatus, and system for implementing proxy accounting for a home agent

(75) Inventor: Adiseshu Channasamudhram, Bartlett, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Inc.

(21) Appl. No.: 11/024,062

(22) Filed: Dec. 28, 2004

(51) Int. Cl. H04Q 7/00

(52) U.S. Cl. 370/328

(57) ABSTRACT

Proxy accounting for a home agent is implemented. Packets are monitored on a home network. A registration request sent from a mobile node connected to a foreign network to a home agent residing on the home network is detected among the packets, corresponding to a registration sought by the mobile node on the foreign network. A registration reply sent from the home agent to the mobile node is detected among the packets, indicating that the home agent approves the registration. It is determined that the registration is new. An accounting-start indication is caused to be recorded for the registration. A registration-termination request sent to the home agent is detected among the packets, seeking termination of the registration. A registration-termination reply sent from the home agent is detected among the packets, acknowledging termination of the registration. An accounting-stop indication is caused to be recorded for the registration.

### BACKGROUND

1. Technical Field

The claims and examples of embodiments relate to the Mobile Internet Protocol and, more particularly, to implementing proxy accounting for one or more home agents.

2. Description of Related Art

Increasingly, people are connecting to the Internet using mobile devices. For example, laptop computers are used by business travelers, and cellular telephones and personal digital assistants are used by people from many locations to access information about such topics as sports and weather. To accomplish this communication, these devices typically connect—physically or wirelessly—to a network that has been established wherever they are.

To handle this mobility, a protocol known as the Mobile Internet Protocol (“Mobile IP”) was developed, enabling these mobile devices (“mobile nodes”) to maintain a static or at least semi-permanent Internet Protocol (“IP”) address, to which other devices can transmit data bound for the mobile nodes, no matter where the mobile nodes happen to be currently attached to the Internet. Mobile IP is described in RFC 3344, “IP Mobility Support for IPv4,” (August 2002), which is incorporated herein by reference.

In Mobile IP, each mobile node has a “home network,” on which sits a device known as the mobile node's home agent (“HA”). Under standard IP routing, all data addressed to a mobile node will be routed to the mobile node's HA. When the mobile node is on its home network, the HA will send any such data to the mobile node, as would a typical router. When a mobile node is on another network, known as a “foreign network,” the mobile node informs the HA of its location. In that case, the HA sends any data addressed to the mobile node to a device on the foreign network known as a foreign agent (“FA”), which delivers the data to the mobile node. The FA also routes data sent from the mobile node over the Internet to its intended destination.

Users of these mobile nodes are typically billed by their particular Internet Service Provider (ISP) for using the provider's packet-data communication service. In the case of cellular wireless devices, the ISP is typically also the provider of cellular wireless service to the device generally. Thus, users typically have a particular service plan with their service provider that includes packet-data service. To accurately compute bills for their users, service providers require accurate data-service usage records, regardless of whether that usage took place on the mobile node's home network, on one or more foreign networks, or a combination of the two.

### SUMMARY

In exemplary embodiments, proxy accounting is implemented on the home network. An entity on the home network, perhaps the home agent itself or an accounting proxy, detects the beginning and end of packet-data communication sessions that mobile nodes, which use the home agent as their home agent, engage in on foreign networks. The entity then causes accounting records, such as accounting-start and accounting-stop indications, to be stored on the home network, or in a location accessible to entities on the home network. From these accounting records, data-service usage records may be generated and stored in a location that is accessible to entities on the home network.

As such, one example of an embodiment may take the form of a method. In accordance with the method, packets are monitored on a home network. A registration request sent from a mobile node connected to a foreign network to a home agent residing on the home network is detected among the packets. The registration request corresponds to a registration sought by the mobile node on the foreign network. A registration reply sent from the home agent to the mobile node is detected among the packets. The registration reply indicates that the home agent approves the registration. It is determined that the registration is new. An accounting-start indication is caused to be recorded for the registration. A registration-termination request sent to the home agent is detected among the packets. The registration-termination request seeks termination of the registration. A registration-termination reply sent from the home agent is detected among the packets. The registration-termination reply acknowledges termination of the registration. An accounting-stop indication is caused to be recorded for the registration.

These as well as other aspects and advantages will become apparent to those of ordinary skill in the art by reading the following detailed description, with reference where appropriate to the accompanying drawings.

### BRIEF DESCRIPTION OF THE DRAWINGS

Various examples of embodiments are described herein with reference to the following drawings, wherein like numerals denote like entities.

FIG. 1 is a simplified block diagram of an example of a communications system, in accordance with examples of embodiments;

FIG. 2 is a simplified block diagram of an example of an accounting proxy, in accordance with examples of embodiments;

FIG. 3 is a flowchart of an example of an embodiment, in the form of a method carried out along the communications system of FIG. 1;

FIG. 4 is a call flow diagram, illustrating an example of the messaging and processing that could occur if proxy accounting were implemented, in accordance with examples of embodiments, where deregistration is requested by a mobile node; and

FIG. 5 is a call flow diagram, illustrating an example of the messaging and processing that could occur if proxy accounting were implemented, in accordance with examples of embodiments, where registration revocation is requested by a foreign agent.

### DETAILED DESCRIPTION OF THE DRAWINGS

1. Overview

In Mobile IP, each mobile node (e.g., laptop, cell phone, etc.) is assigned a “home network,” which will typically be the network on which the mobile node was provisioned for service. On the home network sits an entity known as a “home agent.” The home agent (HA) maintains data records for each mobile node that calls that particular network their home network. Among other data, for each mobile node, the home agent will store a “home address,” which is an IP address associated with the mobile node on at least a semi-permanent basis. Entities seeking to transmit data to a mobile node may transmit the data to the mobile node's home address, and may query the home agent to discover this home address if necessary.

When a mobile node connects to a network other than its home network, that network is referred to as a “foreign network” with respect to the mobile node. An entity on the foreign network known as a “foreign agent” (FA) facilitates the mobile node's use of the foreign network. The mobile node typically begins the process of establishing connectivity via a foreign network by establishing a data link, such as a point-to-point protocol (PPP) connection, with an entity on the foreign network known as a packet data serving node (PDSN). The FA is typically a functional part of the PDSN, though they could also be separate entities. The mobile node then requests registration as a visiting mobile node by sending a “Mobile Registration Request” message over the PPP connection to the FA.

The registration request typically includes an indication of the IP address of the mobile node's HA, to which the FA will then transmit the request. If the HA approves the request, it will transmit a “Mobile Registration Reply” message back to the FA, indicating approval. The HA will also store an association—known as a “mobility binding” or “mobility binding record”—between the home address of the mobile node (which the HA may concurrently assign to the mobile node) and the 1P address of the FA. Upon receiving the reply, the FA adds an entry for the mobile node to a “visitor list” of currently-registered mobile nodes maintained by the FA, usually storing the mobile node's IP address in the visitor-list entry. To complete the registration process, the FA sends the reply to the mobile node, indicating success.

Once registration has taken place, not only may the mobile node transmit IP packets over the Internet via the foreign agent, but the mobile node may also now receive IP traffic sent to the mobile node's home address via “IP encapsulation” or “tunneling,” described in RFC 2003, “IP Encapsulation within IP” (October 1996), which is incorporated herein by reference. IP encapsulation builds on the fact that, due to standard IP routing and addressing, IP traffic addressed to the mobile node's home address will be routed to the mobile node's HA. For any mobile nodes for which the HA is currently maintaining an unexpired mobility binding, the HA will intercept this traffic and route it to the FA indicated by the respective mobility binding.

The HA “encapsulates” or “tunnels” the data to the indicated FA by adding an “outer IP header” to each packet. The outer IP header will indicate the HA as the source address of the packet and the FA's IP address as the destination address of the packet, essentially treating the combined header and payload of the original packet as the payload of the new packet. Upon receipt of the encapsulated packet, the FA “decapsulates” it by removing the outer IP header, and delivers it to the visiting mobile node over the previously-established PPP connection.

In addition to enabling a visiting mobile node to receive packets addressed to the mobile node's home IP address, the foreign agent enables the visiting mobile node to send packets over the Internet. Foreign agents typically accomplish this via standard IP routing. That is, when a visiting mobile node transmits a packet to another entity, the FA will route the packet out on to the Internet, where standard IP routing mechanisms will transport the packet to its destination. The FA may, however, implement “reverse tunneling,” whereby the FA would “tunnel” to the mobile node's HA all packets sent from the mobile node; the HA would then decapsulate them and transmit them to their intended destination, as described in RFC 3024, “Reverse Tunneling for Mobile IP, revised,” (January 2001), which is incorporated herein by reference.

When the user of the mobile node is finished engaging in packet-data communication via the FA, the user may terminate the communication session by entering a “disconnect” command (perhaps by closing an application or selecting a “disconnect” or “exit” option). In response, the mobile node will typically send a Mobile IP deregistration request message to the FA, which the FA will then transmit to the mobile node's HA. The HA will then transmit a deregistration reply to the FA, confirming termination of the session, and remove the mobility binding associating the mobile node's home address with the FA's IP address. Upon receipt of the deregistration reply, the FA sends the deregistration reply to the mobile node, confirming the end of the communication session. The FA will also remove the entry relating to the mobile node from the FA's visitor list. At this point, the mobile node is no longer registered on the foreign network.

However, it may also be the case that the mobile node's communication session ends abruptly, without the mobile node sending a deregistration message to the FA. This may occur if the user of the mobile node, for example, simply closes a “flip phone” without first entering a disconnect command. An abrupt termination of the communication session may also result from a sudden loss of power to the mobile node, or perhaps a loss of a signal from a wireless network.

However the abrupt termination of the session occurs, the FA will not receive any communication from the mobile node for some amount of time. Once a sufficient amount of time passes, the FA will consider the mobile node's registration (communication session) to have “timed out.” In that case, the FA will send a Mobile IP “registration revocation” message to the mobile node's HA. Similar to the deregistration case, the HA will send a registration-revocation reply to the FA, acknowledging termination of the registration, and remove the mobility binding that the HA was maintaining for the mobile node. Upon receipt of the registration-revocation reply, the FA will remove the entry pertaining to the mobile node from the FA's visitor list. The mobile node is at that point no longer registered to engage in data communication via the FA.

For accounting purposes, the FA typically facilitates the storage of data-service usage information on an accounting server on the foreign network (“the foreign accounting server”). When the FA receives the registration reply from the HA, approving the registration of the mobile node on the foreign network, in addition to transmitting this reply to the mobile node and adding an entry for the mobile node to the FA's visitor list, the FA will typically send an “accounting-start” message to the foreign accounting server.

And whether the mobile node's registration terminates by deregistration or revocation, as described above, the FA at the time of registration termination typically sends an accounting-stop message to the foreign accounting server. These accounting-start and accounting-stop messages (and perhaps other accounting messages) sent from the FA to the foreign accounting server may comply with a protocol such as RADIUS, described in RFC 2865, “Remote Authentication Dial In User Service (RADIUS),” (June 2000) and RFC 2866, “RADIUS Accounting,” (June 2000), which are incorporated herein by reference. Based on these accounting messages, the foreign accounting server generates accounting records for the mobile node, which the mobile node's Internet Service Provider would then typically have to make arrangements to somehow acquire.

In various embodiments, the storage of accounting-related information is performed by one or more entities on the home network, and the accounting-related data may be stored on an accounting server residing on the home network, or at least accessible to entities on the home network (“the home accounting server”). In one embodiment, a device referred to as an accounting proxy is connected to a segment of the home network such that the accounting proxy may monitor the Internet Protocol (IP) packets that are transmitted both to and from the home agent. In one embodiment, the accounting proxy monitors the packets without disrupting or altering the IP traffic sent to and from the home agent.

In one embodiment, the accounting proxy detects among the packets a registration request sent from a mobile node to the HA, requesting a registration of the mobile node on a foreign network (via a foreign agent on the foreign network). When the accounting proxy detects a corresponding registration reply sent from the HA to the mobile node (via the FA) approving the registration, the accounting proxy sends an accounting-start message (such as a RADIUS accounting-start message) to the home accounting server.

In one embodiment, the accounting proxy later detects a registration-termination message, which may be a deregistration or registration-revocation message, sent from either the mobile node (via the FA) or the FA, seeking termination of the mobile node's registration on the foreign network. When the accounting proxy detects a reply to the registration-termination message, sent from the HA to either the mobile node (via the FA) or to the FA, the accounting proxy sends an accounting-stop message to the home accounting server. The home accounting server will thus be able to generate usage records accessible to entities on the home network pertaining to the mobile node's communication session on the foreign network, and would not necessarily be dependent on the foreign network for obtaining this information.

2. Example Architecture

a. Example Communications System

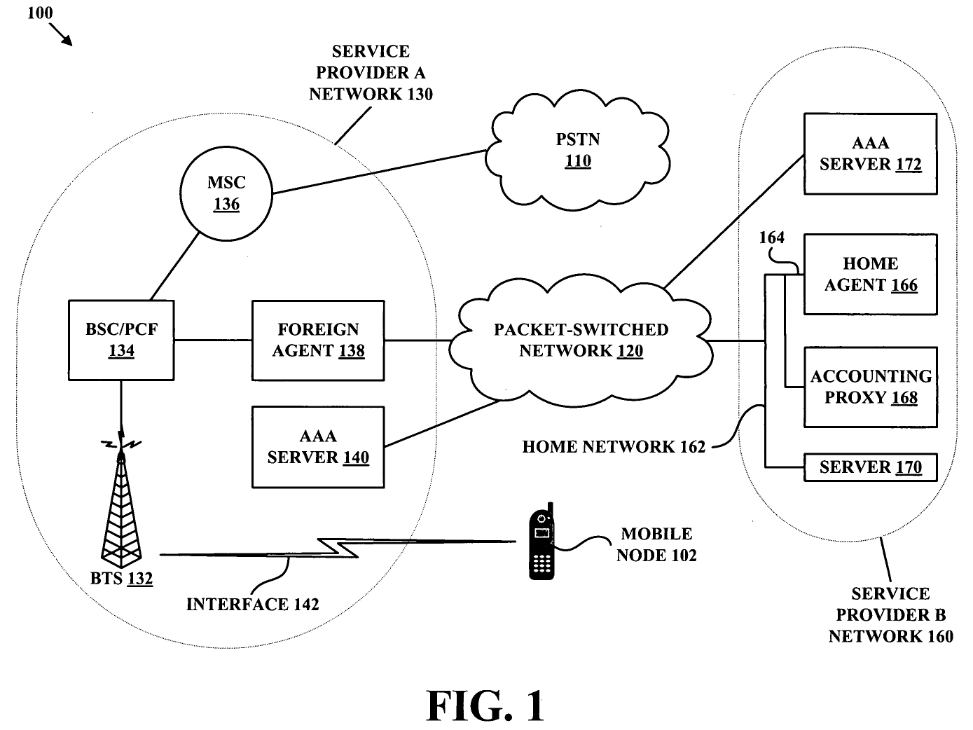

FIG. 1 is a simplified block diagram of an example of a communications system, in accordance with examples of embodiments. It should be understood that this and other arrangements described herein are set forth only as examples. Those skilled in the art will appreciate that other arrangements and elements (e.g., machines, interfaces, functions, orders, and groupings of functions, etc.) can be used instead, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. Various functions may be carried out by a processor executing instructions stored in memory.

As shown in FIG. 1, the communications system 100 includes a mobile node 102, a Public Switched Telephone Network (PSTN) 110, a packet-switched network 120, a network 130 operated by a service provider denoted “service provider A” (“service provider A network 130” or “network 130”), and a network 160 operated by a service provider denoted “service provider B” (“service provider B network 160” or “network 160”).

The PSTN 110 is a circuit-switched network for routing calls between telephones over conventional telephone lines, and is well known in the art. The packet-switched network 120 may include one or more wide area networks (WANs), one or more local area networks (LANs), one or more public networks such as the Internet, one or more private networks, one or more wired networks, and/or one or more wireless networks. Devices in communication with the network 120 may transmit and receive data using a packet-switched protocol such as the Internet Protocol (IP), and may be identified by an address such as an IP address.

The mobile node 102 may be any device capable of packet-data communication and arranged to function as a Mobile IP mobile node. The mobile node 102 is associated with a home agent 166, described below, such that the mobile node 102 may alter its point of attachment to the Internet while maintaining a semi-permanent “home” IP address, as described above. As examples, the mobile node 102 may be a cellular telephone, a personal digital assistant (PDA), a computer, a desktop computer, or a laptop computer. The mobile node 102 may also itself be a foreign agent, arranged to serve some number of other mobile nodes. As a further example, the mobile node 102 could be a router, such as a wireless router. The mobile node 102 may take other forms as well, without departing from the scope of the claims. In the examples of embodiments described herein, the mobile node 102 is a cellular telephone.

The service provider A network 130 includes a Base Transceiver Station (BTS) 132, a base station controller/packet control function (BSC/PCF) 134, a mobile switching center 136, a foreign agent (FA) 138, and an authentication, authorization, and accounting (AAA) server 140. To provide service to the mobile node 102, the BTS 132 provides a wireless coverage area, and communicates over a wireless air interface 142 with the mobile node 102 in the coverage area.

The communication between the BTS 132 and the mobile node 102 may occur in a digital format, such as Code Division Multiple Access (CDMA), Time Division Multiple Access (TDMA), Global System for Mobile Communications (GSM), 3rd Generation (3G) wireless communications, or Institute of Electrical and Electronics Engineers (IEEE) 802.11x, or an analog format, such as Advanced Mobile Phone Service (AMPS). Some examples of embodiments use a digital format known as cdma2000(, described in “CDMA 2000® Series,” TIA/EIA/IS-2000 Series, Release A (2000), which is incorporated herein by reference.

The BTS 132 may be controlled by the BSC/PCF 134, which, in turn, may be controlled by the MSC 136. The MSC 136 may be connected to the PSTN 110, and may use a signaling system, such as SS7, to route calls through the PSTN 110. The MSC 136 may be able to communicate with one or more Home Location Registers (HLRs) (not shown) and one or more Service Control Points (SCPs) (not shown), typically via one or more Signal Transfer Points (STPs) (not shown). And although FIG. 1 shows the MSC 136 connected to one BSC/PCF and shows the BSC/PCF 134 connected to one BTS, in general, the MSC 136 may be connected to more than one BSC/PCF and each BSC/PCF may be connected to more than one BTS.

The mobile node 102 uses the MSC 136 and an HLR (not shown) for authentication for access to wireless resources. When the mobile-node 102 requests a wireless traffic channel, the MSC 136 may send an authentication request to an HLR associated with the mobile node 102. The signaling between the MSC 136 and the HLR may conform to “Cellular Radiotelecommunications Intersystem Operations,” ANSI/TLA/EIA-41-D-97 (December 1997) and “Addendum 1” thereto, ANSI/TIA/ELA/41-D-1-2002 (April 2002), which are incorporated herein by reference. The signaling between the MSC 136 and an SCP (not shown) may conform to “Wireless Intelligent Network,” TIA/EIA/IS-771 (July 1999), and “Addendum 1” thereto, TIA/EIA/IS-771-1 (August 2001), which are incorporated herein by reference. Other signaling protocols may be used as well.

To enable the mobile node 102 to engage in packet-data communication over the packet-switched network 120, the BSC/PCF 134 includes a packet control function (PCF), and the FA 138 connects the BSC/PCF 134 to the network 120. The FA 138 may be a functional component of a packet data serving node (PDSN), which is an entity known to those in the art, but could in some embodiments be an entity distinct from the PDSN. As such, this description at times refers to the FA 138 as “the PDSN/FA 138” with respect to functions typically carried out by a PDSN. The communication between the BSC/PCF 134, the MSC 136, and the PDSN/FA 138 may conform to “Wireless IP Network Standard,” 3GPP2 P.S0001-A v3.0 (July 2001) and “Interoperability Specification (IOS) for cdma2000 Access Network Interfaces,” 3GPP2 A.S0011˜17-A v2.0.1 (December 2003), which are incorporated herein by reference.

Briefly, under these specifications, the mobile node 102 may request access to the network 120 by sending a packet-data origination request to the MSC 136. The MSC 136 then signals to the BSC/PCF 134, which in turn signals to the PDSN/FA 138. The PDSN/FA 138 and the mobile node 102 then negotiate to establish a data link. If this is successful, a data link, such as a point-to-point protocol (PPP) connection, is established between the mobile node 102 and the PDSN/FA 138. The PDSN/FA 138 may then act as a network access server, providing the mobile node 102 access to the packet-switched network 120. Alternatively or additionally, other network elements—such as an interworking function (IWF) between the MSC 136 and the network 120—may be present for providing the mobile node 102 access to the network 120.

The mobile node 102 would typically be identified on the network 120 by a network address, such as an IP address, which may be dynamically assigned using a Mobile IP process. According to this process, the mobile node 102 may transmit a Mobile IP registration request to the PDSN/FA 138. The PDSN/FA 138 may then transmit, via the network 120, the registration request to the home agent 166, which is the home agent associated with the mobile node 102.

If the HA 166 approves the request, the HA 166 may dynamically assign an IP address to the mobile node 102, or the mobile node 102 may use an IP address permanently assigned to it. Either way, the HA 166 transmits a Mobile IP registration reply to the PDSN/FA 138, approving the request for the registration. The HA 166 will also store a mobility binding, associating the home IP address of the mobile node 102 with the IP address of the FA 138.

Upon receipt of the registration reply, the FA 138 transmits the reply to the mobile node 102 over the PPP connection previously established between the PDSN/FA 138 and the mobile node 102, thereby informing the mobile node 102 of the successful registration. The FA 138 will also store an entry for the mobile node 102 in the FA 138's visitor list, associating the home address of the mobile node 102 with the established PPP connection.

At that point, the mobile node 102 is registered on the network 130, known as a foreign network (“foreign network 130”) with respect to the mobile node 102, since the mobile node 102's home network is another network (a home network 162, described below), which is part of the service provider B network 160. In operation, when an entity in communication with the network 120 transmits packet data to the mobile node 102's home IP address, that data will be routed due to standard IP addressing and routing mechanisms to the HA 166. The HA 166 will then reference the mobility binding stored for the mobile node 102, and tunnel the packet data to the FA 138 for delivery to the mobile node 102. And packet data transmitted by the mobile node 102 will be routed either out on to the network 120 for delivery to its intended destination, or to the HA 166, if the mobile node 102 is arranged to engage in reverse tunneling, explained above.

The service provider B network 160 includes the home network 162, the home agent 166, an accounting proxy 168, a server 170, and an authentication, authorization, and accounting (AAA) server 172. The home network 162 is a private IP network operated by the service provider B, which operates the network 160 as a whole. In some embodiments, the home network 162 may be separated from the network 120 with a firewall (not shown) and/or network access server (not shown), both of which are known in the art.

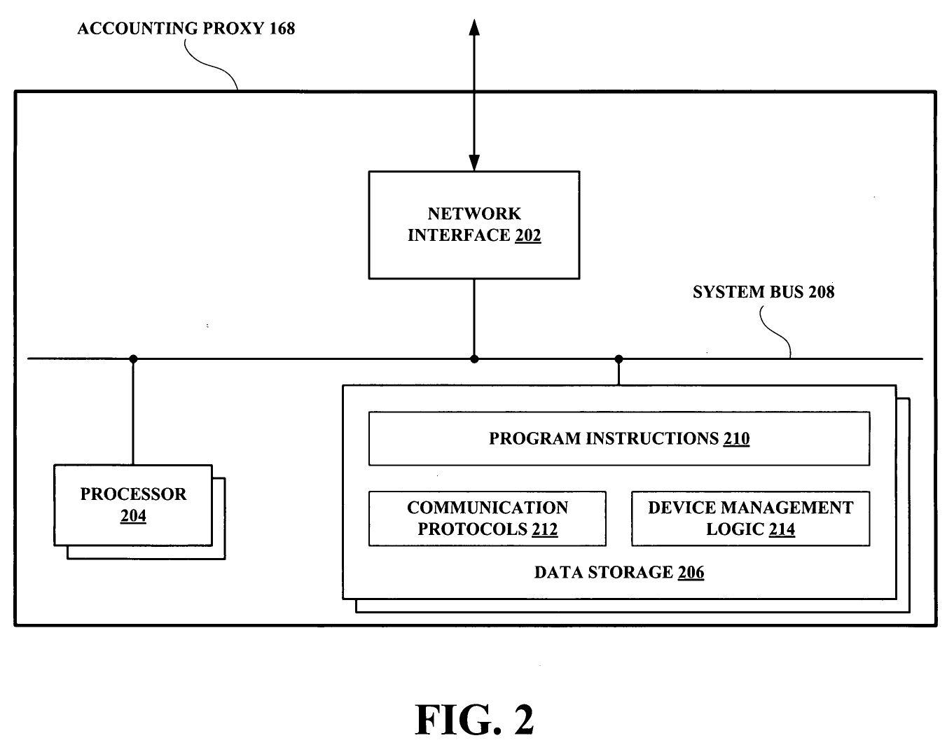

The HA 166 and the accounting proxy 168 are both connected to the home network 162 via a network segment 164, such that the accounting proxy 168 can monitor packets transmitted to and from the HA 166. The HA 166 may take the form of a network server, programmed to carry out the functions of a Mobile IP home agent, known in the art. The accounting proxy 168 is further explained in connection with FIGS. 2-6. The server 170 is connected to the home network 162, and may be any type of network server known in the art. Although the AAA server 172 is connected to the network 120, it is operated by the service provider B, and is accessible to entities on the network 160. Or, AAA server 172 could be connected to the home network 162.

b. Example Accounting Proxy

FIG. 2 is a simplified block diagram of an example of an accounting proxy, in accordance with examples of embodiments. In particular, FIG. 2 is a diagram of the accounting proxy 168 of FIG. 1, and includes a network interface 202, a processor 204, and a data storage 206, all communicatively linked by a system bus 208. In general, the accounting proxy 168 may be any device programmed to carry out the functions described herein.

The network interface 202 enables the accounting proxy 168 to communicate over the home network 162, including monitoring the IP packets on the network segment 164, transmitted to and from the HA 166. As such, the network interface 202 may include an Ethernet adapter. Instead or in addition, the accounting proxy 168 may communicate wirelessly with the home network 162, in which case the network interface 202 may include a wireless-communication chipset and antenna. The network interface 202 may also include circuitry to communicate locally with other devices (e.g., routers or modems) over a physical connection (e.g., an Ethernet cable), or a wireless connection (e.g., wireless LAN), using a protocol such as IEEE 802.11x, or perhaps Bluetooth® technology. Those devices may then communicate with home network 162.

The processor 204 may control many of the operations of the accounting proxy 168 by executing a set of program instructions 210 stored in the data storage 206, and may comprise multiple (e.g., parallel) processors, such as a general purpose microprocessor and/or a discrete digital signal processor.

The data storage 206 may store the program instructions 210, a set of communication protocols 212, and a set of device management logic 214. The data storage 206 may take various forms, in one or more parts, such as a non-volatile storage block and/or a removable storage medium. The program instructions 210 may comprise program instructions executable by the processor 204 to carry out various functions described herein.

The communication protocols 212 may be used to receive and send data over the home network 162 and beyond, and to monitor IP packets on the network segment 164 of the home network 162, and may include Session Initiation Protocol (SIP), HyperText Transfer Protocol (HTTP), Real-Time Transport Protocol (RTP), Transmission Control Protocol (TCP), User Datagram Protocol (UDP), Internet Protocol (IP), Simple Mail Transfer Protocol (SMTP), Dynamic Host Configuration Protocol (DHCP), Domain Name Service (DNS), Internet Control Message Protocol (IMCP), RADIUS, Point-to-Point Protocol (PPP), IEEE 802.11×, Bluetooth®, one or more proprietary protocols, and any other communication protocols. Compatible communication protocols may be stored in other devices on the home network 162, as well as on other devices in communication with other networks, such as the AAA server 172 in communication with the network 120. The device management logic 214 may be used to manage aspects of the accounting proxy 168 such as memory and file management.

3. Example Operation

a. Example Method

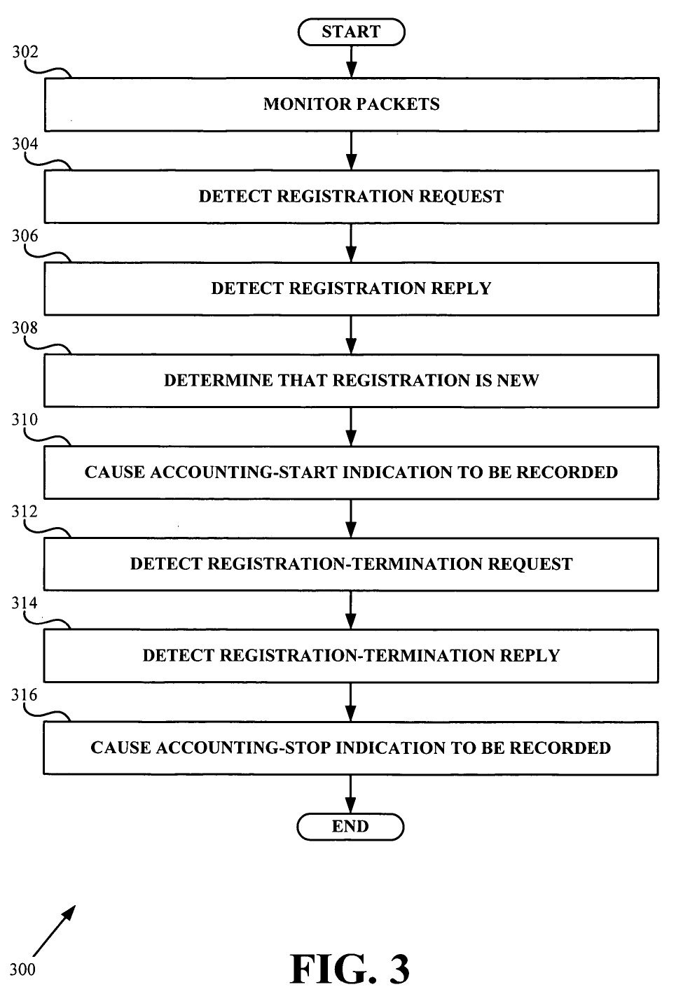

FIG. 3 is a flowchart of an example of an embodiment, in the form of a method carried out along the communications system of FIG. 1. As shown in FIG. 3, the method 300 begins at step 302, when the accounting proxy 168 monitors IP packets on the network segment 164 of the home network 162. Thus, the accounting proxy 168 monitors the packets transmitted to and from the HA 166, which is connected to the home network 162 via the network segment 164. The accounting proxy 168 carries out step 302 such that the IP traffic to and from the HA 166 is not altered or disrupted. Thus, the HA 166 may be implemented as a standard Mobile IP home agent. The accounting proxy 168 may be thought of as carrying out a “listening,” “packet sniffing,” or “packet capture” function, and may use utilities such as PCAP and TCPDUMP.

At step 304, the accounting proxy 168 detects among the packets a registration request sent from the mobile node 102 connected to the foreign network 130 to the home agent 166 residing on the home network 162. As explained above, the mobile node 102 would first have acquired access to the network 130's radio resources, and then established a PPP connection between the mobile node 102 and the PDSN/FA 138. Then, the mobile node 102 would have transmitted a Mobile IP registration request message to the FA 138, which would have then sent the registration request to the HA 166 over the network 120.

It is this registration request that the accounting proxy 168 detects in step 304. From the fields in the IP header of the packet or packets sent from the mobile node 102 to the HA 166 via the FA 138, the accounting proxy 168 determines that the mobile node 102 has transmitted a registration request to the HA 166. This registration request corresponds to the mobile node 102 seeking a Mobile IP registration on the foreign network 130, as explained herein.

At step 306, in the manner described above with respect to step 304, the accounting proxy 168 detects among the packets a registration reply sent from the home agent 166 to the mobile node 102. The HA 166 transmits this registration reply, bound for the mobile node 102, to the FA 138 for transmission to the mobile node 102. The registration reply indicates that the HA 166 approves the registration of the mobile node 102 on the foreign network 130. The HA 166 may dynamically assign an IP address to the mobile node 102 for the mobile node 102 to use as its home IP address, or the mobile node 102 may be programmed to use a permanently assigned home IP address. In any case, the HA 166 will store a mobility binding associating the mobile node 102's home IP address with the FA 138's IP address.

At step 308, the accounting proxy 168 determines that the registration—for which the HA 166 sent the approving registration reply in step 306—is a new registration, and not a re-registration, of the mobile node 102 on the foreign network 130. In Mobile IP, registrations of mobile nodes expire after a certain amount of time. So, mobile nodes, such as the mobile node 102, that wish to continue engaging in packet-data communication via a foreign network, such as the foreign network 130, are programmed to re-register periodically. The re-registration process is very similar to the registration process, in that it involves a mobile node sending a registration request to its HA, the HA responding with a registration reply, and the HA and FA updating their mobility bindings and visitor list, respectively. Through re-registration, mobile nodes replenish their registration lifetime, which would otherwise expire.

The accounting proxy 168 is programmed to ignore registration requests and registration replies that correspond to re-registration of the mobile node 102 on the foreign network 130. The accounting proxy 168 may determine that the registration reply of step 306 corresponds to a new registration by reference to a communication-session database maintained by the accounting proxy 168. The communication-session database may be locally stored in the data storage 206 of the accounting proxy 168, or remotely stored, perhaps in a server such as the server 170.

The communication-session database may include a list of indicators, where each indicator indicates that a particular mobile node is currently registered with the HA 166 and engaging in a communication session on a foreign network. Thus, the accounting proxy 168 may check this list as part of determining that the registration requested in step 304 and approved in step 306 is new. If the list contains an indicator corresponding to the mobile node 102, then the mobile node 102 is currently registered with the HA 166 and engaging in a communication session on a foreign network, and the registration is therefore not new. If the list does not, however, include an indicator corresponding to the mobile node 102, then the registration is new. As an example, the list may be organized by the mobile nodes' home IP addresses.

If, responsive to detecting the registration reply in step 306, the accounting proxy 168 determines, at step 308, that the communication-session database does not include an indicator corresponding to the mobile node 102, and thus that the registration is new, the accounting proxy 168 updates the communication-session database to include an indicator corresponding to the mobile node 102, so that the accounting proxy 168 will be able to determine that any subsequent registrations—while the indicator is still stored in the communication-session database—are re-registrations, and may be ignored for the purpose of proxy accounting.

At step 310, following the determination in step 308 that the registration requested in step 304 and approved in step 306 is a new registration, the accounting proxy 168 causes an accounting-start indication to be recorded for the registration. In one embodiment, the accounting proxy 168 may maintain a local database of accounting information, and carry out step 310 by storing the accounting-start indication in the accounting database.

This accounting-start indication may take the form of a data record that identifies the mobile node 102 by home IP address or by some other identifier, such as the mobile node 102's mobile identification number (MIN), which is typically the directory phone number by which a mobile node such as the mobile node 102 is reachable for voice calls. The identifier may also be a network access identifier (NAI), known in the art, of the form user@domain. The data record would also likely include an indication of the date and time that the mobile node 102 was approved for registration, and began the current communication session. The data record would also likely include some form of identifier for the session itself, and may include other data.

In other embodiments, the accounting proxy 168 may carry out step 310 by sending an accounting-start message to an accounting server, such as the AAA server 172. This message may comply with the RADIUS protocol, and include some or all of the data described in the preceding paragraph, and perhaps other data as well. The accounting-start message may be a RADIUS accounting-start message, requesting that the AAA server 172 store an indication of the beginning of the communication session for the mobile node 102 on the foreign network 130.

At step 312, after the mobile node 102 has engaged in packet-data communication for some time, the accounting proxy 168 detects among the packets on the network segment 164 of the home network 162 a registration-termination request sent to the HA 166, seeking termination of the registration of the mobile node 102 on the foreign network 130. As explained, this registration-termination request may be a deregistration request sent from the mobile node 102 to the HA 166 via the FA 138. This could occur following the user of the mobile node 102 entering a disconnect command via a user interface of the mobile node 102, indicating a desire to terminate the session, and thus the registration. Or, the registration-termination request could be a registration-revocation request sent from the FA 138 following an abrupt termination of the communication session, such as the closing of a flip phone or a loss of power or wireless signal, or some other cause of an abrupt termination.

At step 314, the accounting proxy 168 detects among the packets a registration-termination reply sent from the HA 166, acknowledging termination of the registration. If the registration-termination request detected in step 312 was a deregistration request sent from the mobile node 102 via the FA 138, the registration-termination reply detected in step 314 would likely be a deregistration reply sent from the HA 166 to the mobile node 102 via the FA 138. If, however, the registration-termination request of step 312 was a registration-revocation request sent from the HA 166 to the FA 138, the registration-termination reply of step 314 would likely be a registration-revocation reply sent from the HA 166 to the FA 138. And other forms of registration-termination requests and replies are possible as well.

Responsive to detecting the registration-termination reply in step 314, the accounting proxy 168 may update the communication-session database described above to remove the indicator indicating that the mobile node 102 is currently registered and engaged in a communication session on a foreign network. Therefore, a subsequent registration request-and-reply sequence, corresponding to a subsequent approved registration for the mobile node 102, will properly be determined by the accounting proxy 168 to be a new registration.

At step 316, the accounting proxy 168 causes an accounting-stop indication to be recorded for the registration. Similar to the accounting-start indication of step 310, the accounting-stop indication of step 316 could take the form of a data record stored in a locally or remotely accessible accounting database. In other embodiments, the accounting proxy 168 may carry out step 316 by sending an accounting-stop message, such as a RADIUS accounting-stop message, to an accounting server such as the AAA server 172.

And other RADIUS (or another protocol) messages may be sent, or records stored, in addition to the accounting-start and accounting-stop indications described herein. For example, the accounting proxy 168 could cause indications to be stored relating to the number of packets sent and/or received by the mobile node 102 during the time the mobile node 102 is registered on the foreign network 130. This could be facilitated by the mobile node 102 being programmed to engage in reverse tunneling, as described herein, such that all IP traffic sent to or from the mobile node 102 would pass through the HA 166, and thus be observable to the accounting proxy 168 on the home network 162. And other accounting metrics could be stored as well.

Thus, by virtue of the accounting proxy 168 carrying out the method 300, the service provider B will have accounting data related to the mobile node 102's communication session via the foreign network 130 stored on the AAA server 172 or other local database, which will be accessible to network entities, such as billing servers (not shown), on the network 160. Service provider B need not negotiate with service provider A to obtain this accounting information. Service provider B will thus be more independent, and can be more confident in the integrity and accuracy of the accounting records, since they were generated and stored by service provider B itself, and not by an unknown entity. For example, if service provider B were concerned about incompleteness of the accounting records typically maintained by service provider A, proxy accounting could partially or completely alleviate this concern.

Once the accounting records described above have been stored, one or more entities such as billing servers may use these records, among other information, to bill the user of the mobile node 102. The billing could be as simple as a flat or by-the-minute rate, or more complicated. For example, the accounting proxy 168 could be programmed to detect among the packets sent to or from the mobile node 102 any number of values in the packet header or payload of the IP packets. As examples, the accounting proxy 168 could detect identifiers indicating what application the packets pertain to, what type of content is carried by the packets, the source address of one or more of the packets, the destination address of one or more of the packets, as well as any other values, and generate bills for the user of the mobile node 102 accordingly.

And although FIG. 3 has been described in the context of the accounting proxy 168 carrying out the functions described herein, these functions could also be carried out by the HA 166 itself. As the HA 166 inherently has access to and monitors all IP packets sent to and from the HA 166, it is in a position to carry out the described functions as well.

b. Example Call Flows

i. Where Proxy Accounting is Implemented (Deregistration Requested by Mobile Node)

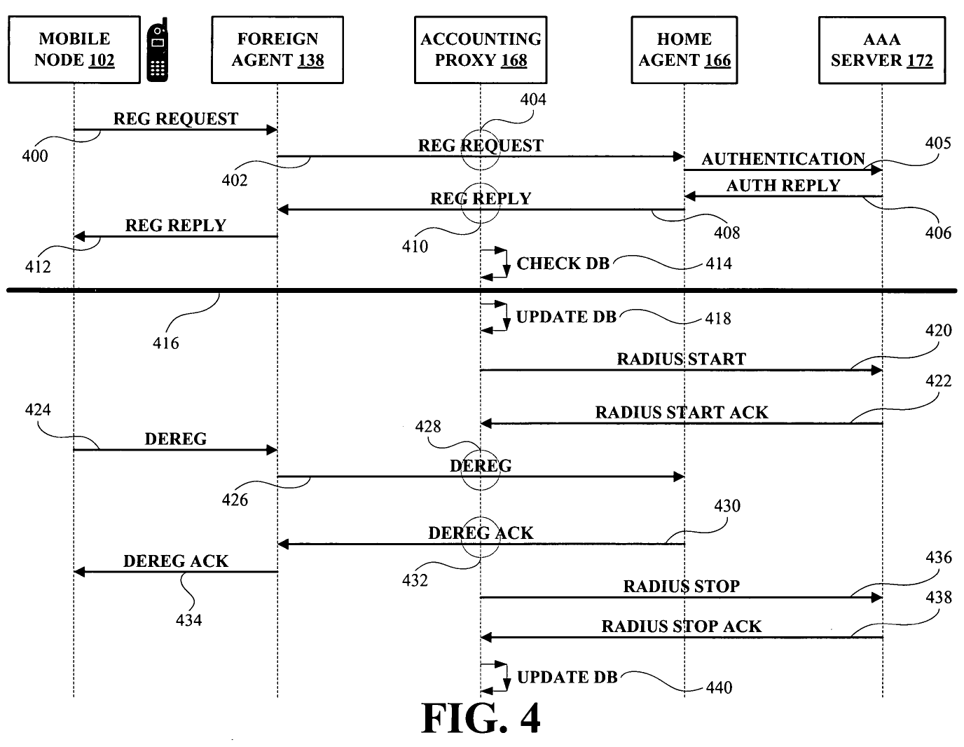

FIG. 4 is a call flow diagram, illustrating an example of the messaging and processing that could occur if proxy accounting were implemented, in accordance with examples of embodiments, where deregistration is requested by a mobile node. The call flow of FIG. 4 begins at step 400, when the mobile node 102 sends a registration request to the FA 138, seeking a registration of the mobile node 102 on the foreign network 130. At step 402, the FA 138 sends the registration request to the mobile node 102's home agent, HA 166, on the home network 162.

Because the accounting proxy 168 is monitoring IP packets transmitted to and from the HA 166 on the network segment 164 of the home network 162, at step 404, the accounting proxy 168 detects the registration request of step 402. At steps 405 and 406, the HA 166 transmits an authentication request to and receives an authentication reply from the AAA server 172, indicating that the registration request of step 402 was authenticated, and that the HA 166 may therefore approve the registration of the mobile node 102 on the foreign network 130.

Therefore, at step 408, the HA 166 sends a registration reply to the FA 138, indicating approval of the registration, and at step 412, the FA 138 sends the registration reply to the mobile node 102. The HA 166 stores a mobility binding associating the home IP address of the mobile node 102 (which the HA 166 may at that time assign) with the IP address of the PDSN/FA 138. The FA 138 adds an entry to its visitor list associating the home address of the mobile node 102 with the established PPP connection between the mobile node 102 and the PDSN/FA 138.

At step 410, the accounting proxy 168 detects the registration reply of step 408 on the home network 162. At step 414, the accounting proxy 168 responsively checks whether its communication-session database, described above, includes an indicator that the mobile node 102 is currently registered on a foreign network, such as the foreign network 130.

If, at step 414, the accounting proxy 168 determines that its communication-session database does include an indicator indicating that the mobile node 102 is currently registered on a foreign network, and thus currently engaged in a packet-data communication session, the messaging and processing below the line 416 of FIG. 4 would not occur. The accounting proxy 168 would ignore the registration request detected at step 404 and the registration reply detected at step 410, since they would correspond to a re-registration of the mobile node 102.

If, however, at step 414, the accounting proxy 168 determines that its communication-session database does not include an indicator pertaining to the mobile node 102, the messaging and processing shown below the line 416 of FIG. 4 would occur. In that case, at step 418, the accounting proxy 168 updates its communication-session database to include an indicator indicating that the mobile node 102 is registered for packet-data communication on the foreign network 130. At step 420, the accounting proxy 168 sends a RADIUS accounting-start message to the AAA server 172, which is accessible to entities on the network 160. At step 422, the AAA server 172 sends an acknowledgment of the accounting-start message to accounting proxy 168.

Between steps 412 and 424, the mobile node 102 may engage in one or more types of packet-data communication. Once the user of the mobile node 102 enters a disconnect command into the mobile node 102 via the mobile node 102's user interface, at step 424, the mobile node 102 transmits a deregistration request to the FA 138. At step 426, the FA 138 sends the deregistration request to the HA 166. At step 430, the HA 166 sends a deregistration reply to the FA 138, acknowledging the deregistration of the mobile node 102 on the foreign network 130. At step 434, the FA 138 sends the deregistration reply to the mobile node 102 over the established PPP connection.

At steps 428 and 432, the accounting proxy 168 detects on the home network 162 the deregistration request of step 426 and the deregistration reply of step 430, respectively. Responsive to detecting the deregistration reply of step 430 at step 432, corresponding to the termination of the registration of the mobile node 102 on the foreign network 130, at step 436, the accounting proxy 168 transmits a RADIUS accounting-stop message to the AAA server 172. At step 438, the AAA server 172 transmits a response to the accounting proxy 168, acknowledging receipt of the accounting-stop message of step 436.

At step 440, the accounting proxy 168 updates its communication-session database to remove the indicator indicating that the mobile node 102 is registered for packet-data communication on a foreign network. As a result of the messaging and processing of FIG. 4, the AAA server 172, accessible to entities on the network 160, contains one or more usage records pertaining to the mobile node 102's packet-data communication session on network 130.

ii. Where Proxy Accounting is Implemented (Registration Revocation Requested by Foreign Agent)

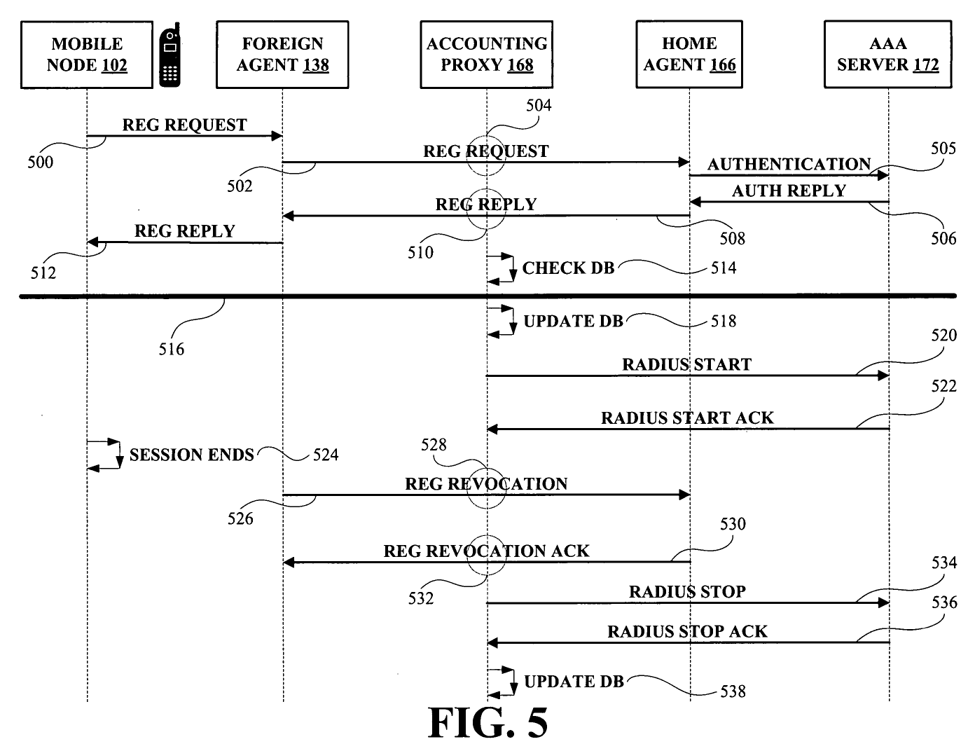

FIG. 5 is a call flow diagram, illustrating an example of the messaging and processing that could occur if proxy accounting were implemented, in accordance with examples of embodiments, where registration revocation is requested by a foreign agent. The messaging and processing of steps 500-522 of FIG. 5 match that of steps 400-422 of FIG. 4. Thus, the messaging and processing below the line 516 of FIG. 5 occurs only if, at step 514, the accounting proxy 168 determines that its communication-session database does not include an indicator indicating that the mobile node 102 is currently registered on a foreign network.

If, at step 514, the accounting proxy 168 determines that its communication-session database does include such an indicator, the messaging and processing below the line 516 would not occur, as the presence of this indicator would indicate that the registration request of step 502 and the registration reply of step 508, detected by the accounting proxy 168 at steps 504 and 510, respectively, correspond to re-registration of the mobile node 102 on a foreign network.

And, similar to FIG. 4, the mobile node 102 may engage in any amount of any type of packet-data communication between steps 512 and 524. At step 524, the packet-data session in which the mobile node 102 was engaging ends abruptly. As explained, if the mobile node 102 is a “flip phone,” this abrupt termination may occur if the user simply closes the flip phone without first entering some form of a disconnect command via the user interface of the mobile node 102. This abrupt termination may also occur if the mobile node 102 suddenly loses either power or a signal from a wireless network. The abrupt termination may have other causes as well.

As a result of the abrupt termination of the mobile node 102's communication session, the FA 138 will not receive any communication from the mobile node 102 for a sufficiently long enough period of time such that the FA 138 will determine that the connection between the FA 138 and the mobile node 102 has “timed out.” As a result, at step 526, the FA 138 transmits a registration-revocation message to the HA 166, requesting that the HA 166 acknowledge the termination of the mobile node 102's registration on the network 130. At step 530, the HA 166 transmits a registration-revocation reply to the FA 138, providing this acknowledgement.

At steps 528 and 532, the accounting proxy 168 detects on the home network 162 the registration-revocation request of step 526 and the registration-revocation reply of step 530, respectively. As a result of the detection at step 532 of the registration-revocation reply of step 530, at step 534, the accounting proxy 168 transmits a RADIUS accounting-stop message to the AAA server 172, indicating the termination of the registration and therefore the packet-data communication session of the mobile node 102 on the foreign network 130. At step 536, the AAA server 172 transmits a reply to the accounting proxy 168, acknowledging the termination.

Finally, at step 538, the accounting proxy 168 updates its communication-session database to remove the indicator indicating that the mobile node 102 is registered on and engaging in packet-data communication via a foreign network such as the network 130. Thus, similar to the result of the messaging and processing of FIG. 4, due to the messaging and processing of FIG. 5, the AAA server 172, accessible to the network entities of the server provider B network 160, contains one or more accounting records related to the mobile node 102's packet-data communication session on the service provider A network 130.

4. Conclusion

Various examples of embodiments have been described above. Those skilled in the art will understand, however, that changes and modifications may be made to those examples without departing from the scope of the claims.

1. A method comprising:
monitoring packets on a home network;
detecting among the packets a registration request sent from a mobile node connected to a foreign network to a home agent residing on the home network, the registration request corresponding to a registration sought by the mobile node on the foreign network;
detecting among the packets a registration reply sent from the home agent to the mobile node, the registration reply indicating that the home agent approves the registration;
determining that the registration is new;
causing an accounting-start indication to be recorded for the registration;
detecting among the packets a registration-termination request sent to the home agent, the registration-termination request seeking termination of the registration;
detecting among the packets a registration-termination reply sent from the home agent, the registration-termination reply acknowledging termination of the registration; and
causing an accounting-stop indication to be recorded for the registration.

2. The method of claim 1, carried out by the home agent.

3. The method of claim 1, carried out by an entity other than the home agent.

4. The method of claim 1, further comprising ignoring registration requests and registration replies that correspond to re-registration of the mobile node.

5. The method of claim 1, further comprising:
maintaining a communication-session database, wherein the communication-session database comprises an indicator corresponding to the mobile node when the mobile node is engaged in a communication session, and wherein the communication-session database does not comprise the indicator when the mobile node is not engaged in a communication session;
responsive to detecting the registration reply, updating the communication-session database to include the indicator; and
responsive to detecting the registration-termination reply, updating the communication-session database to remove the indicator.

6. The method of claim 5, wherein determining that the registration is new comprises determining that the communication-session database does not include the indicator.

7. The method of claim 5, further comprising ignoring registration requests and registration replies that correspond to re-registration of the mobile node.

8. The method of claim 7, wherein ignoring registration requests and registration replies that correspond to re-registration of the mobile node comprises determining that the communication-session database includes the indicator.

9. The method of claim 1, wherein causing the accounting-start indication to be recorded comprises storing the accounting-start indication in an accounting database, and causing the accounting-stop indication to be recorded comprises storing the accounting-stop indication in the accounting database.

10. The method of claim 1, wherein causing the accounting-start indication to be recorded comprises sending an accounting-start message to an accounting server, and causing the accounting-stop indication to be recorded comprises sending an accounting-stop message to the accounting server.

11. The method of claim 1, wherein (i) the registration-termination request is a request selected from the group consisting of (a) a deregistration request sent from the mobile node and (b) a registration-revocation request sent from a foreign agent residing on the foreign network, and (ii) the registration-termination reply is a reply selected from the group consisting of (a) a deregistration reply sent to the mobile node and (b) a registration-revocation reply sent to the foreign agent.

12. The method of claim 1, further comprising billing a user of the mobile node based at least in part on the accounting-start indication and the accounting-stop indication.

13. The method of claim 1, further comprising:
detecting among the packets sent to or from the mobile node an application identifier, a content-type identifier, a source identifier, or a destination identifier; and
billing a user of the mobile node based at least in part on the detected identifier.

14. An accounting proxy comprising:
a network interface in communication with a home network;
a processor; and
a data storage comprising program instructions executable by the processor to:
monitor packets on the home network,
detect among the packets a registration request sent from a mobile node connected to a foreign network to a home agent residing on the home network, the registration request corresponding to a registration sought by the mobile node on the foreign network,
detect among the packets a registration reply sent from the home agent to the mobile node, the registration reply indicating that the home agent approves the registration,
determine that the registration is new,
cause an accounting-start indication to be recorded for the registration,
detect among the packets a registration-termination request sent to the home agent, the registration-termination request seeking termination of the registration,
detect among the packets a registration-termination reply sent from the home agent, the registration-termination reply acknowledging termination of the registration, and
cause an accounting-stop indication to be recorded for the registration.

15. The accounting proxy of claim 14, wherein the accounting proxy is part of the home agent.

16. The accounting proxy of claim 14, wherein the accounting proxy is an entity residing on the home network, distinct from the home agent.

17. The accounting proxy of claim 14, wherein the data storage further comprises program instructions executable by the processor to ignore registration requests and registration replies that correspond to re-registration of the mobile node.

18. The accounting proxy of claim 14, wherein the data storage further comprises program instructions executable by the processor to:
maintain a communication-session database, wherein the communication-session database comprises an indicator corresponding to the mobile node when the mobile node is engaged in a communication session, and wherein the communication-session database does not comprise the indicator when the mobile node is not engaged in a communication session;
responsive to detecting the registration reply, update the communication-session database to include the indicator; and
responsive to detecting the registration-termination reply, update the communication-session database to remove the indicator.

19. The accounting proxy of claim 18, wherein the program instructions executable by the processor to determine that the registration is new comprise instructions to determine that the communication-session database does not include the indicator.

20. The accounting proxy of claim 18, wherein the data storage further comprises program instructions executable by the processor to ignore registration requests and registration replies that correspond to re-registration of the mobile node.

21. The accounting proxy of claim 20, wherein the program instructions executable by the processor to ignore registration requests and registration replies that correspond to re-registration of the mobile node comprise instructions to determine that the communication-session database includes the indicator.

22. The accounting proxy of claim 14, wherein the program instructions executable by the processor to cause the accounting-start indication to be recorded comprise instructions to store the accounting-start indication in an accounting database, and the program instructions executable by the processor to cause the accounting-stop indication to be recorded comprise instructions to store the accounting-stop indication in the accounting database.

23. The accounting proxy of claim 14, wherein the program instructions executable by the processor to cause the accounting-start indication to be recorded comprise instructions to send an accounting-start message to an accounting server, and the program instructions executable by the processor to cause the accounting-stop indication to be recorded comprise instructions to send an accounting-stop message to the accounting server.

24. A method of proxy accounting for a home agent residing on a home network, the method comprising:
detecting on the home network a new registration for a mobile node connected to a foreign network;
causing an accounting-start indication to be recorded for the registration;
detecting on the home network a termination of the registration; and
causing an accounting-stop indication to be recorded for the registration.

25. The method of claim 24, carried out by the home agent.

26. The method of claim 24, carried out by an entity other than the home agent.

27. The method of claim 24, further comprising ignoring at least one re-registration of the mobile node.

28. The method of claim 24, wherein causing the accounting-start indication to be recorded comprises storing the accounting-start indication in an accounting database, and causing the accounting-stop indication to be recorded comprises storing the accounting-stop indication in the accounting database.

29. The method of claim 24, wherein causing the accounting-start indication to be recorded comprises sending an accounting-start message to an accounting server, and causing the accounting-stop indication to be recorded comprises sending an accounting-stop message to the accounting server.
